(19) United States
(12) Patent Application Publication
(10) Pub. No.: US 2007/0101342 A1
(43) Pub. Date: May 3, 2007

(54) Automated device driver management

(75) Inventors: Brett D.A. Flegg, Redmond, WA (US); Anthony Baron, Woodinville, WA (US); Daniel N.J. Drew, Valencia, CA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/263,084

(22) Filed: Oct. 31, 2005

(51) Int. Cl. G06F 9/46

(52) U.S. Cl. 719/321

(57) ABSTRACT

Techniques for importing, managing, and deploying drivers are provided. When a machine is being re-imaged, a process on the machine scans for hardware devices on the machine and generates a list of hardware device IDs and compatible hardware device IDs for each scanned hardware device. The process then formulates a request for device driver package IDs corresponding to device drivers that are compatible with the hardware and compatible hardware device IDs, and sends the request to a management server. The process receives a list of compatible device driver package IDs in response to the request and accesses the device driver files from an appropriate content server.

### BACKGROUND

It is not uncommon for an organization to have hundreds, if not thousands of machines, such as personal computers, work stations, servers, clients, etc. While some of these machines may be the same (i.e., same computer model from the same manufacturer), it is not uncommon for many of the machines to be different (i.e., different computer model from many different manufacturers). Furthermore, machines of the same model (i.e., machines within the same model line) may be different due to differences in hardware and hardware configuration.

Generally speaking, a device driver is needed to access and use the hardware components, such as a video card, sound card, keyboard, mouse, etc., of the machine. For example, a video driver is normally needed to use a video card that is contained in a machine. The device driver allows an operating system and other software programs executing on the machine to communicate with and utilize the hardware components of the machine. Therefore, each of the different machines (i.e., machines that have different hardware configurations) will need a different set of device drivers.

Managing and deploying the different device drivers or sets of device drivers onto the large number of machines in an organization presents a major challenge. System administrators typically create a monolithic image that contains every single device driver that may be needed by the machines in the organization. The monolithic image is then deployed to every machine in the organization, and the operating system on each machine is burdened with the task of determining which of the drivers in the monolithic image need to be loaded on the machine. When a new machine requiring a new device driver is added, the monolithic image needs to be rebuilt to include the new device driver, and the rebuilt monolithic image may need to be redistributed to all content servers in an organization. This process of managing and deploying device drivers using a monolithic image can be extremely time consuming and costly.

### SUMMARY

Techniques for importing, managing, and deploying drivers are provided. When a machine is being re-imaged, a process on the machine scans for hardware devices on the machine and generates a list of hardware device IDs and compatible hardware device IDs for each scanned hardware device. The process then formulates a request for device driver package IDs corresponding to device drivers that are compatible with the hardware and compatible hardware device IDs, and sends the request to a management server. The process receives a list of compatible device driver package IDs in response to the request and accesses the device driver files from an appropriate content server.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high-level block diagram illustrating an example environment in which a driver management system that implements the driver importing, managing, and deploying techniques may operate.

FIG. 2 is a flow diagram that illustrates the addition of a device driver to a driver catalog, according to some embodiments.

FIG. 3 is a block diagram that illustrates metadata associated with a driver catalog device driver package, according to some embodiments.

FIG. 4 is a flow diagram that illustrates the processing of a component of a management server that receives a request for a list of driver package IDs, according to some embodiments.

FIG. 5 is a flow diagram that illustrates the processing of a target machine in a pre-installation environment to add device driver packages, according to some embodiments.

### DETAILED DESCRIPTION

Various techniques for importing, managing, and deploying drivers, such as device drivers, are provided. In some embodiments, a system administrator imports the device drivers into a device catalog that comprises the device drivers that are to be considered in an image deployment onto a target computer system (also referred to herein as a “machine”). A server, such as a management server, may provide a user interface (UI) that may be accessed through, for example, a system administrator console, and which can be used to import and manipulate driver manufacturers' device driver packages, such as WINDOWS Device Driver Packages, into the driver catalog. For example, when machines requiring a new device driver are purchased, or a new version of a device driver is released, the administrator can use the UI to import the device drivers into the driver catalog, and the imported device drivers will be considered in future image deployment tasks, such as operating system (OS) deployment tasks, which utilize the driver catalog. In some embodiments, the driver catalog may provide an interface, such as an application program interface (API), which allows third-party tools (e.g., third-party device driver providers) to import device drivers into the driver catalog.

In some embodiments, the management server may provide a tool, such as a WINDOWS Import Driver Wizard, which guides its user, such as an administrator, through the process of adding a driver to the driver catalog. For example, the tool may prompt the administrator to provide a manufacturer's driver package, such as the driver package disk, directory, compact disk (CD), etc. The tool parses the installation instructions provided with the manufacturer's driver package to determine metadata associated with the driver package. In the case of WINDOWS Device Driver Packages, the tool may parse the associated information (.inf) file to determine the metadata associated with the WINDOWS device driver package. The tool may allow the administrator to provide additional metadata that should be associated with the driver package. The tool saves the metadata associated with the driver package in the driver catalog. The tool encapsulates the driver files associated with the manufacturer's driver package into a driver catalog driver package, and assigns the driver catalog driver package to one or more content servers.

In some embodiments, the management server services driver matching requests. For example, a target machine may send the management server a request for driver IDs compatible with a list of hardware IDs. The request includes a description of the target machine and a list of hardware device IDs to find driver IDs for. The management server may then query a database, such as the driver catalog, and determine the drivers in the database that are compatible with the indicated hardware device IDs. In addition to the hardware device IDs, the management server may query the database using factors such as the target machine's make, model, OS, processor architecture, etc., to determine the set of compatible drivers. The management server then determines the driver IDs corresponding to the drivers that are compatible with the hardware device IDs, and returns a list of compatible driver package IDs as a response to the target machine. A driver package ID uniquely identifies a driver catalog driver package (e.g., driver metadata and source) in the driver catalog. In some embodiments, the management server ranks the drivers that are compatible with the indicated hardware device IDs, and provides a ranked list of compatible driver package IDs.

In some embodiments, a target machine executing a minimal OS uses the services of the management server to add device drivers to the target machine. For example, the minimal OS may be executed during an OS deployment task on the target machine, and executing the minimal OS places or causes a pre-installation environment or state to be created on the target machine. The pre-installation environment exists when an image (e.g., minimal OS image) has been applied to the target machine, but before the target machine has been rebooted into a full OS. In some embodiments, while in the pre-installation environment, a software facility (“facility”) on the target machine scans for the hardware devices that are on the machine and generates a list of hardware IDs for the scanned hardware devices. The facility then obtains a list of driver package IDs that are compatible with the hardware IDs in the list of hardware IDs. For example, the facility may formulate and send the management server a request for driver packages compatible with the hardware IDs in the list of hardware IDs, and receive from the management server the list of compatible driver package IDs. In some embodiments, the facility can configure an offline OS on the target machine to consider using the drivers in the driver packages. For example, the offline OS can be configured to consider the drivers in its plug-and-play pass. In some embodiments, the driver catalog functionality (the services of the management server to add device drivers to the target machine) can be used for making drivers available for a new OS installation (e.g., configuring a scripted installation of an operating system to use the given set of device drivers).

In some embodiments, the facility also obtains compatible hardware IDs for the scanned hardware devices, and includes the compatible hardware IDs in the list of hardware IDs. Thus, the list of compatible driver IDs also includes the driver IDs that are compatible with the compatible hardware IDs. In some embodiments, the facility checks to determine if an obtained driver package is for a “boot critical driver.” If so, the facility installs the boot critical driver on the target machine. In some embodiments, the facility ranks the hardware IDs in the list of hardware IDs.

The various techniques allow the target machine to obtain (e.g., download) only the drivers that it needs (e.g., the drivers that are compatible with the hardware devices that are on the target machine), thus requiring less network bandwidth and speeding up the image deployment process.

In one embodiment, the various techniques for importing, managing, and deploying drivers described herein may be implemented as part of a software distribution system, such as MICROSOFT's System Management Server (SMS). SMS provides an architecture for managing large groups of WINDOWS-based computer systems. SMS provides administrators the ability to manage the machines on a network, distribute software to the machines from a central location, detect the machines on the network, track software and hardware configurations, and perform other tasks on the machines from a remote location.

The SMS architecture and environment constitutes but one suitable paradigm in which the driver importing, managing, and deploying techniques described herein can take place. One skilled in the art will appreciate that other paradigms provided by any of a variety of well-known software configuration and release management systems may be utilized to implement the techniques for importing, managing, and deploying drivers described herein.

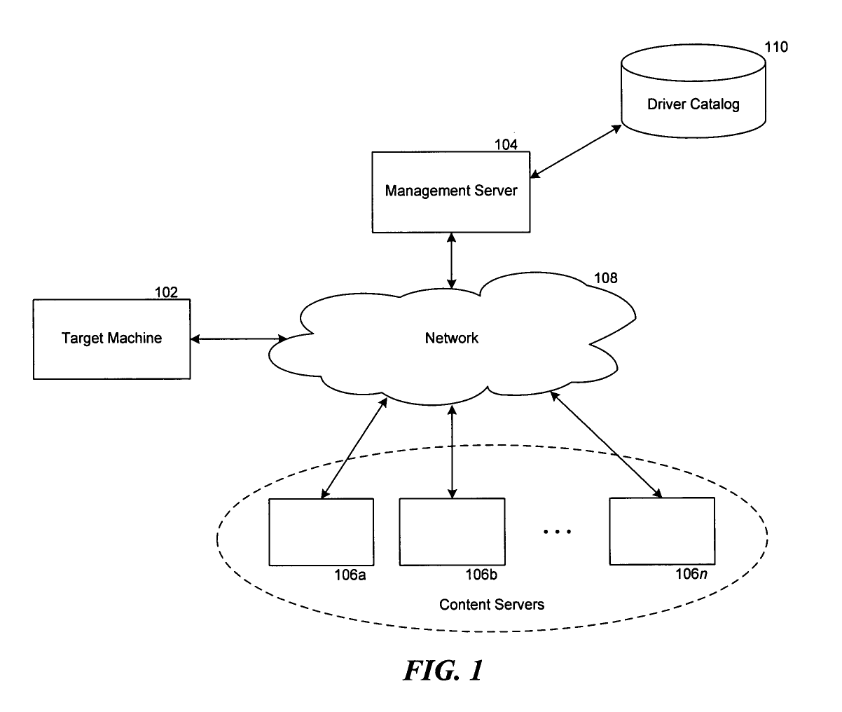

FIG. 1 is a high-level block diagram illustrating an example environment in which a driver management system that implements the driver importing, managing, and deploying techniques may operate. The operating environment is only one example of a suitable operating environment and is not intended to suggest any limitation as to the scope of use or functionality of the driver management system. As depicted, the environment comprises a target machine 102, management server 104, and a plurality of content servers 106a-n, each coupled to a network 108. The management server is also coupled to a driver catalog 110. Only one target machine is shown in FIG. 1 for simplicity and one skilled in the art will appreciate that there may be more than one target machine. As used herein, the terms “connected,” “coupled,” or any variant thereof, means any connection or coupling, either direct or indirect, between two or more elements; the coupling or connection between the elements can be physical, logical, or a combination thereof.

When a new device driver is acquired, for example, such as when a company purchases a machine or a peripheral device that requires a new device driver, an administrator invokes a tool, such as an Import Driver Wizard, provided by the management server to add the device driver to the driver catalog. As part of this process, the administrator may provide additional metadata that is to be associated with the added device driver. The management server then creates a device driver package from the provided device driver and the metadata associated with the device driver, including any additional metadata that was provided by the administrator, and adds the device driver package to the driver catalog. The management server distributes the newly added device driver package to one or more content servers. Within the SMS context, content servers provide content servers, which can effectively serve as geographically dispersed file shares where individual machines can obtain the device driver packages. The device driver packages in the driver catalog are then considered in future OS deployment tasks on the target machine. For example, when the target machine is being re-imaged (e.g., a boot image is being re-imaged (also referred to as re-installed) on the target machine), the facility executing on the target machine, while the target machine is in a pre-installation state, scans for the hardware devices on the target machine and obtains a list of hardware IDs and compatible hardware IDs for each hardware device. The facility then formulates a driver catalog request and sends the request to the management server. Upon receiving the request from the target machine, the management server queries the driver catalog to determine a set of compatible hardware driver package IDs that are available in the driver catalog. The management server then returns the set of compatible hardware driver package IDs as a response to the target machine. In some embodiments, the management server may rank the set of compatible driver package IDs that are returned to the target machine. For example, the compatible driver package IDs may be ranked using MICROSOFT's standard plug-and-play matching algorithm, which is generally known to those of ordinary skill in the art. The facility receives the set of compatible hardware driver IDs and obtains the device driver packages corresponding to the hardware driver IDs from the respective content servers. If an obtained device driver package is for a mass storage device, the facility installs the driver on the target machine. Otherwise, the facility copies the obtained device driver package to, for example, the target machine's device driver store, and configures the offline OS on the target machine to consider the device driver corresponding to the device driver package. The facility may log a warning (e.g., a warning message) for any hardware driver IDs for which a corresponding device driver package was not obtained.

In some embodiments, the facility may also query the target machine's local device driver store and determine a ranked order of compatible devices on the target machine. The facility can then merge the response received from the management server and the target machine's local device driver store, and select a best match (i.e., the most appropriate) device driver. For example, the facility can enumerate all device drivers in the local machine's driver cache and calculate a driver rank (e.g., a number between 0x0000 and 0XFFFF) for each device driver. The facility can then compare the highest ranked device driver in the local driver cache with the highest ranked device driver in the driver catalog and choose the lower of the two. If there is a tie, the facility can pick the device driver with the higher version number.

In general terms, the network is a communications link that facilitates the transfer of electronic content between, for example, the attached target machine, management server and content servers. In some embodiments, the network includes the Internet. It will be appreciated that the network may be comprised of one or more other types of networks, such as a local area network, a wide area network, a point-to-point dial-up connection, and the like.

The computing device on which the driver management system, including the target machine, management server, and content servers, is implemented may include a central processing unit, memory, input devices (e.g., keyboard and pointing devices), output devices (e.g., display devices), and storage devices (e.g., disk drives). The memory and storage devices are computer-readable media that may contain instructions that implement the driver management system. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

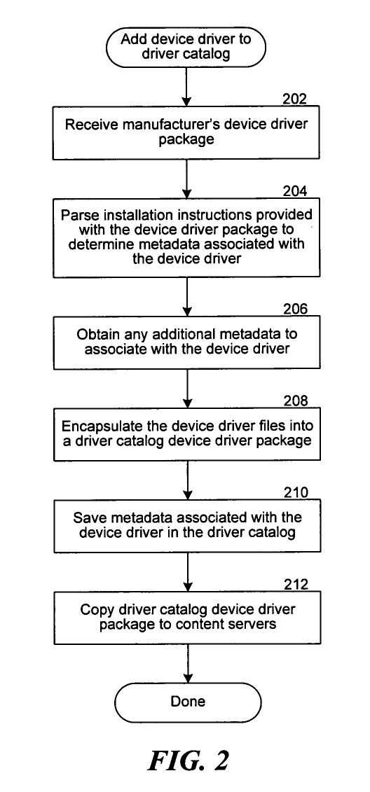

FIG. 2 is a flow diagram that illustrates the addition of a device driver to a driver catalog, according to some embodiments. By way of example, an organization may receive from a manufacturer (e.g., the manufacturer of a hardware device and/or the developer of a device driver) a device driver package for a new version or release of the device driver for the hardware device. In order that the new version of the device driver can be considered in future deployments of the OS on the organization's machines, the organization's administrator may utilize the management server to add or import the device driver package into the driver catalog. In block 202, the management server receives the manufacturer's device driver package. In block 204, the management server parses the installation instructions that are provided with the device driver package to determine the metadata associated with the device driver. In block 206, the management server obtains any additional metadata to associate with the device driver. For example, the management server may provide a UI through which the administrator may provide additional metadata and/or edit the metadata associated with the device driver. In block 208, the management server saves the metadata (i.e., the metadata parsed from the installation instructions (block 204) and any additional metadata provided by the administrator (block 206)) associated with the device driver in the driver catalog. In block 210, the management server encapsulates the device driver files into a driver catalog device driver package. The device driver files are the files that were received as part of the manufacturer's device driver package. The management system may also store the driver catalog device driver package in the driver catalog or other suitable storage device. In block 212, the management server copies the driver catalog device driver package to a content server or multiple content servers for subsequent deployment to target machines.

One skilled in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps.

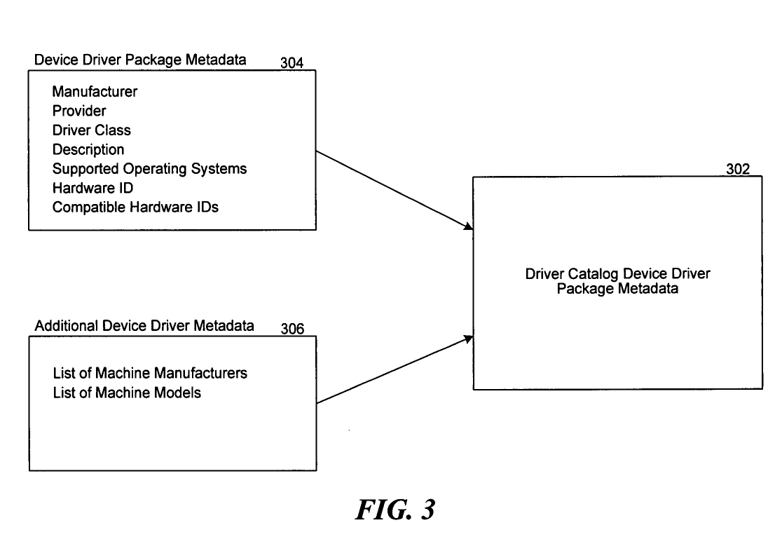

FIG. 3 is a block diagram that illustrates metadata associated with a driver catalog device driver package, according to some embodiments. A driver catalog device driver package metadata 302 is formulated from the combination of a device driver package metadata 304 and additional device driver metadata 306. The device driver package metadata is the metadata that is parsed from the installation instructions provided with the device driver package, for example, as described in connection with block 204 above. As depicted, the metadata may include, by way of example, the manufacturer of the hardware device for which the device driver applies, the provider of the device driver (e.g., the developer of the device driver), the class of device driver (e.g., SCSI device driver, video device driver, etc.), a description of the device driver, the operating systems supported by the device driver, the hardware device IDs of the hardware devices that are compatible with the device driver, and the compatible hardware IDs of the compatible hardware devices that are also compatible with the device driver. The additional device driver metadata is the additional metadata that is to be associated with the device driver package, for example, as described in connection with block 206 above. As depicted, the additional metadata may include, by way of example, a list of machine manufacturers and a list of machine models. The list of machine manufacturers can include zero, one or more machine manufacturers for which the device driver package applies. The list of machine models can include zero, one or more machine models for which the device driver package applies. The driver catalog device driver package metadata may then be used to determine whether the particular driver catalog device driver package is appropriate to be deployed (e.g., installed) on a target machine. For example, the administrator may have indicated that a Device Driver KLM for a Video Card ABC from Company XYZ is appropriate for deployment on machines manufactured by ACME. In this instance, ACME is included in the list of machine manufacturers. Subsequently, if an ACME machine configured with the Video Card ABC requests a list of compatible device driver IDs, the management server includes Device Driver KLM in its response. On the other hand, if a machine that is not manufactured by ACME but which is configured with the Video Card ABC requests a list of compatible device driver IDs, the management server does not include Device Driver KLM in its response even though Device Driver KLM is compatible with Video Card ABC because the requesting machine was not manufactured by ACME. Thus, when present, the additional metadata may serve as a form of “override” to the metadata that was provided with the device driver package received from the manufacturer in determining whether the device driver package is to be deployed on the target machine.

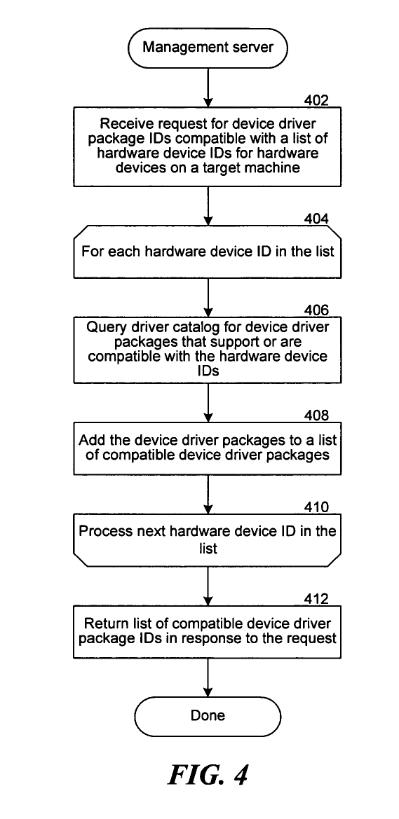

FIG. 4 is a flow diagram that illustrates the processing of a component of a management server that receives a request for a list of driver package IDs, according to some embodiments. By way of example, a target machine may have determined a list of hardware devices for which compatible device drivers are needed. The target machine may have then formulated a list of hardware device IDs for these hardware devices and sent the management server a request for device driver packages that are compatible with the hardware devices identified in the list of hardware device IDs. In block 402, the management server receives the request for device driver package IDs that are compatible with the list of hardware device IDs for hardware devices on the target machine. In some embodiments, the request may also include an indication of the type of target machine (e.g., the manufacturer of the target machine, the model of the target machine, etc.), the OS that is on the target machine, the processor architecture on the target machine, etc. Then, for each hardware device ID in the list of hardware device IDs (block 404), the management server performs blocks 406 to 410, until all the hardware device IDs in the list are processed (block 410). In block 406, the management server queries the driver catalog for device driver packages that support or are compatible with the hardware device ID. For example, the management server may determine whether a device driver is compatible from the metadata associated with the driver catalog device driver package for the device driver. In block 408, the management server adds the compatible device driver packages to a list of compatible device driver packages. For example, the management server can add the device driver package IDs corresponding to the compatible device driver packages to a list of compatible device driver package IDs. Subsequent to processing all the hardware device driver IDs in the list, the management server, in block 412, returns the list of compatible device driver package IDs in response to the request to, for example, the target machine.

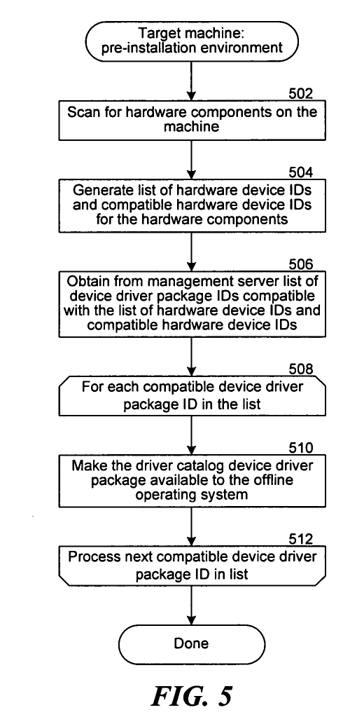

FIG. 5 is a flow diagram that illustrates the processing of a target machine in a pre-installation environment to download device driver packages, according to some embodiments. By way of example, a client process, such as the facility, on the target machine may be running an OS deployment task sequence after an OS image has been applied to the target machine but before the target machine has been rebooted into a “mini setup.” In this state, the target machine is in a pre-installation environment. The pre-installation environment comprises a minimal OS or subset of an OS, such as MICROSOFT's WinPE , that is installed on the target machine's hard disk and re-booted to place the target machine in the pre-installation environment. The minimal OS may be provided via mechanisms, such as, by way of example, CD ROM, RAM Disk, PXE, etc. As is generally known, upon executing the mini setup, the OS corresponding to the OS image is initialized and started, and any machine settings that were previously saved are restored on the target machine. The pre-installation environment is generally understood by one of ordinary skill in the art.

In block 502, the facility executing on the target machine scans the target machine to determine the hardware components that are one the target machine. In block 504, the facility generates a list of hardware device IDs and compatible hardware device IDs for the scanned hardware components. In block 506, the facility obtains from the management server a list of device driver package IDs that are compatible with the list of hardware device IDs and compatible hardware device IDs. Then, for each device driver package in the list of device driver package IDs (block 508), the facility performs block 510, until all the device driver package IDs in the list are processed (block 512). In block 510, the facility makes the driver catalog device driver package available to the offline OS on the machine. For example, the facility can configure the offline OS on the machine to consider the device driver corresponding to the driver catalog device driver package. In some embodiments, the facility may check the driver catalog device driver package to determine if it is for a boot critical driver. If the driver catalog device driver package is for a boot critical driver, the facility installs the boot critical driver on the target machine.

In some embodiments, the facility on the target machine may download device driver packages to the target machine while the target machine is not in the pre-installation environment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method in a computer system for adding device drivers, the method comprising:
installing a minimal operating system on a computer system, the minimal operating system operable to create a pre-installation environment on the computer system;
creating the pre-installation environment on the computer system; and
within the pre-installation environment,
scanning for hardware components on the computer system;
generating a list of hardware device IDs for the scanned hardware components;
obtaining a list of device driver packages compatible with the hardware device IDs in the list of hardware device IDs; and
configuring an offline operating system on the computer system to consider using the device drivers in the device driver packages.

2. The method of claim 1, wherein the list of compatible device driver IDs is obtained from a remote server.

3. The method of claim 1, wherein the device driver packages are obtained from a content server.

4. The method of claim 1, wherein the list of hardware device IDs includes compatible hardware device IDs.

5. The method of claim 1 further comprising:
within the pre-installation environment,
determining whether an obtained device driver package is for a boot critical driver; and
upon determining the obtained device driver package is for a boot critical driver, installing the boot critical driver on the offline computer system.

6. The method of claim 1, wherein the list of hardware device IDs is ranked.

7. The method of claim 1, wherein the offline operating system is configured to consider using the device drivers in its plug-and-play process.

8. The method of claim 1, wherein at least one of the device driver packages is a WINDOWS driver package.

9. The method of claim 1, wherein the minimal operating system is installed over a network.

10. A method in a computer system for adding a device driver to a driver catalog, the method comprising:
receiving a manufacturer's device driver package for a device driver;
parsing installation instructions provided with the device driver package to determine metadata associated with the device driver package;
obtaining any additional metadata to associate with the device driver package;
saving the metadata associated with the device driver package in a driver catalog; and
assigning the device driver package to at least one content server.

11. The method of claim 10, wherein the device driver package is a WINDOWS driver package.

12. The method of claim 10, wherein the metadata and additional metadata are used to determine whether the device driver package should be downloaded to a target machine.

13. The method of claim 10, wherein the additional metadata is obtained from an administrator.

14. The method of claim 10, wherein the additional metadata includes an indication of a target machine manufacturer that the device driver package is appropriate for.

15. The method of claim 10, wherein the additional metadata includes an indication of a target machine model that the device driver package is appropriate for.

16. A method in a computer system for providing device driver package IDs compatible with hardware device IDs, the method comprising:
receiving a request for device driver packages compatible with hardware device IDs in a list of hardware device IDs, the request including a description of a target machine;
for each hardware device ID in the list of hardware device IDs,
obtaining device driver packages compatible with the hardware device ID;
adding device driver package IDs corresponding to the obtained device driver packages to a list of compatible device driver package IDs; and
providing the list of compatible device driver package IDs as a response to the request.

17. The method of claim 16, wherein the list of compatible device driver IDs is ranked.

18. The method of claim 16, wherein the device driver IDs are obtained by querying a database.

19. The method of claim 18, wherein the database is a driver catalog.

20. The method of claim 18, wherein the database comprises metadata associated with device driver packages corresponding to the device driver IDs.
